(19) United States
(12) Patent Application Publication
(10) Pub. No.: US 2016/0030970 A1
(43) Pub. Date: Feb. 4, 2016

(54) PASTE APPLICATION DEVICE

(71) Applicant: PANASONIC INTELLECTUAL PROPERTY MANAGEMENT CO., LTD., Osaka-shi, Osaka (JP)

(72) Inventors: Hiroshi OKAMURA, Yamanashi (JP); Masaaki TOKUNAGA, Yamanashi (JP); Hiroshi OGATA, Yamanashi (JP); Toshihiko NAGAYA, Yamanashi (JP)

(21) Appl. No.: 14/775,167

(22) PCT Filed: Mar. 6, 2014
(86) PCT No.: PCT/JP2014/001252

§ 371 Date: Sep. 11, 2015

(30) Foreign Application Priority Data
Mar. 12, 2013 (JP) 2013-048611

(51) Int. Cl. B05C 5/02; B05C 11/10

(52) U.S. Cl. CPC B05C 5/0216; B05C 11/1005

(57) ABSTRACT

A paste application device includes a substrate holding part that holds a substrate, an application head that applies paste to the substrate, a test-application stage where test-application of the paste is performed, an imaging camera that images the paste applied to the test-application stage by the application head from a lateral direction, and a storage part that stores an image imaged by the imaging camera.

### TECHNICAL FIELD

The present invention relates to a paste application device that applies paste to a substrate prior to mounting of a component on the substrate in a component mounting apparatus.

### BACKGROUND ART

A paste application device is a device that applies paste such as solder paste or an adhesive to a substrate prior to mounting of a component on the substrate in a component mounting apparatus installed in a downstream side, and applies the paste to the substrate in application operation capable of obtaining an optimum application state. Such a paste application device is constructed so that before paste is actually applied to a substrate, the paste is tentatively applied to a test-application stage and the tentatively applied paste is imaged by a camera from above and an application area of the paste is measured (for instance, Patent literature 1). Also, a device constructed so as to measure a height of paste applied to a substrate using a laser displacement meter is known (for example, Patent literature 2).

### CITATION LIST

### Patent Literature

[PLT 1] JP-A-8-206563

[PLT 2] JP-A-8-024749

### SUMMARY OF INVENTION

### Technical Problem

However, the device of Patent literature 1 cannot observe a state of the applied paste accurately since only a planar paste image is obtained. Also, the device of Patent literature 2 has a problem of requiring time taken to grasp a shape of the applied paste since it takes time to process information acquired by the laser displacement meter. Also, the devices of Patent literatures 1 and 2 have a problem that a state of the paste just after application or a situation of stringiness of the paste in operation of application cannot be observed since it is necessary to move a camera for imaging to a position just over the paste after an application head for applying the paste is retracted from above the paste.

Hence, an object of the invention is to solve the problems described above, and to provide a paste application device capable of observing a state of applied paste speedily and accurately.

### Solution to Problem

A paste application device of the invention includes a substrate holding part that holds a substrate, an application head that applies paste to the substrate, a test-application stage where test-application of the paste is performed, an imaging camera that images the paste applied to the test-application stage by the application head from a lateral direction, and a storage part that stores an image imaged by the imaging camera.

In the paste application device described above, the paste application device of the invention includes a relative movement unit that relatively moves the test-application stage and the imaging camera in a horizontal direction.

According to the paste application device of the invention, in the paste application device described above, the imaging camera continuously acquires plural images in a period after the application head downwardly moves to attach the paste to the test-application stage until upward movement of the application head is completed, and the storage part stores the plural acquired images.

In any of the paste application devices described above, the paste application device of the invention includes a paste recognition part that measures a height of the paste from the image of the paste imaged by the imaging camera.

### Advantageous Effects of Invention

The invention includes the imaging camera that images the paste applied to the test-application stage by the application head from the lateral direction, with the result that a state of the applied paste can be observed speedily and accurately.

### BRIEF DESCRIPTION OF DRAWINGS

FIG. 1 is a main perspective view of a paste application device in an embodiment of the invention.

FIGS. 2(a) and 2(b) are operation explanatory diagrams of the paste application device in the embodiment of the invention.

FIG. 3 is a block diagram illustrating a control system of the paste application device in the embodiment of the invention.

FIG. 4 is a flowchart of a main routine illustrating a procedure for executing test-application processing of paste by the paste application device in the embodiment of the invention.

FIG. 5 is a flowchart of a subroutine illustrating the procedure for executing the test-application processing of the paste by the paste application device in the embodiment of the invention.

FIG. 6 is a flowchart of a subroutine illustrating the procedure for executing the test-application processing of the paste by the paste application device in the embodiment of the invention.

FIGS. 7(a) to 7(f) are diagrams illustrating examples of images imaged by a lateral imaging camera of the paste application device in the embodiment of the invention.

FIG. 8 is a diagram illustrating an example of an image imaged by a substrate camera of the paste application device in the embodiment of the invention.

FIG. 9 is a timing chart illustrating application operation of the paste application device in the embodiment of the invention.

### DESCRIPTION OF EMBODIMENTS

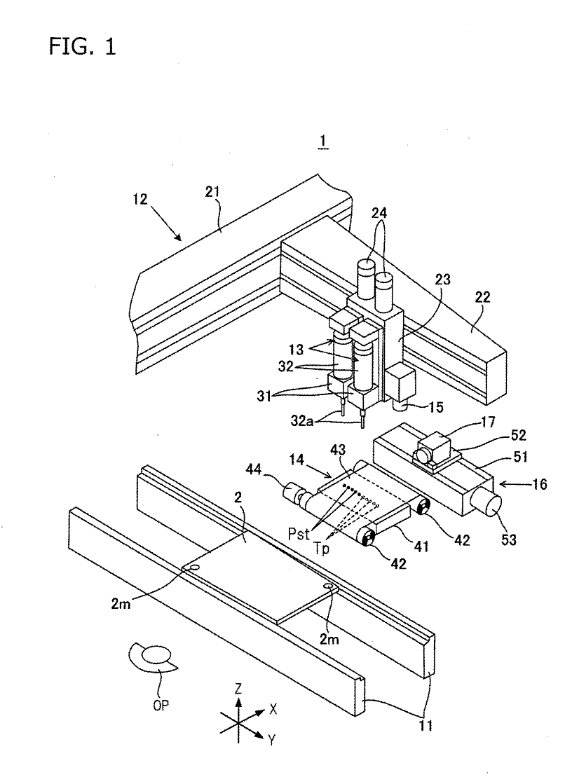

An embodiment of the invention will hereinafter be described with reference to the drawings. A paste application device 1 illustrated in FIG. 1 includes a substrate conveyance conveyor 11 (substrate holding part) that conveys a substrate 2 in a left-right direction (Y-axis direction) viewed from an operator (reference sign OP in FIG. 1) and also holds the substrate 2 in a predetermined work position, two application heads 13 provided movably in a vertical direction (Z-axis direction) and in a horizontal plane over the substrate conveyance conveyor 11 by a head movement mechanism 12 including an XY robot, a test-application stage 14 provided in a side of the substrate conveyance conveyor 11, a substrate camera 15 to be moved together with the two application heads 13 by the head movement mechanism 12, and a lateral imaging camera 17 (imaging camera) provided movably relatively to the test-application stage 14 in the Y-axis direction by a relative movement mechanism 16 provided adjacently to the test-application stage 14.

In FIG. 1, the head movement mechanism 12 includes an X-axis table 21 extending in a front-back direction (X-axis direction) viewed from the operator OP, a Y-axis table 22 extending in the Y-axis direction movable along the X-axis table 21, a movement base 23 movable along the Y-axis table 22, and lifting motors 24 provided on the movement base 23. When the X-axis table 21 is driven, the Y-axis table 22 is moved along the X-axis table 21, and when the Y-axis table 22 is driven, the movement base 23 is moved along the Y-axis table 22. Each of the two application heads 13 is configured to hold a syringe 32 with a lower end of a nozzle 32a facing downwardly in a syringe holding member 31, and has a configuration upwardly and downwardly movable by a lifting mechanism (not illustrated) mounted on the movement base 23. The movement base 23 is equipped with the lifting motors 24 that drive the lifting mechanisms, and the lifting motors 24 are driven to thereby upwardly and downwardly move the two application heads 13 individually. The two application heads 13 are moved in the horizontal plane by combination of movement of the Y-axis table 22 in the X-axis direction with respect to the X-axis table 21 and movement of the movement base 23 in the Y-axis direction with respect to the Y-axis table 22, and are upwardly and downwardly moved with respect to the movement base 23 individually by actuations of the lifting motors 24. Each of the application heads 13 extrudes paste Pst from the lower end of the nozzle 32a by operation of paste ejecting means (not illustrated) provided in correspondence with each of the application heads 13. As the paste ejecting means, a method for pressurizing the paste Pst in the syringe 32 by air pressure, a cylinder, etc., or a mechanical method for forcedly ejecting the paste Pst from the lower end of the nozzle 32a using a screw or a plunger can be applied.

In FIG. 1, the test-application stage 14 is a place where test-application of the paste Pst is performed by the application heads 13, and is configured to have a paper member 43 whose both ends are supported by a pair of roller members 42 rotatable around the Y axis over a stage member 41 with a flat plate shape. An upper surface of the stage member 41 is a test-application region, and plural test-application points Tp at which the paste Pst is tentatively applied by the application head 13 are set in this test-application region at regular intervals in the Y-axis direction. The test-application region is covered with the paper member 43, and can be renewed by rotating and driving the roller members 42 by a motor 44 and moving the paper member 43 to which the paste Pst adheres in the X-axis direction.

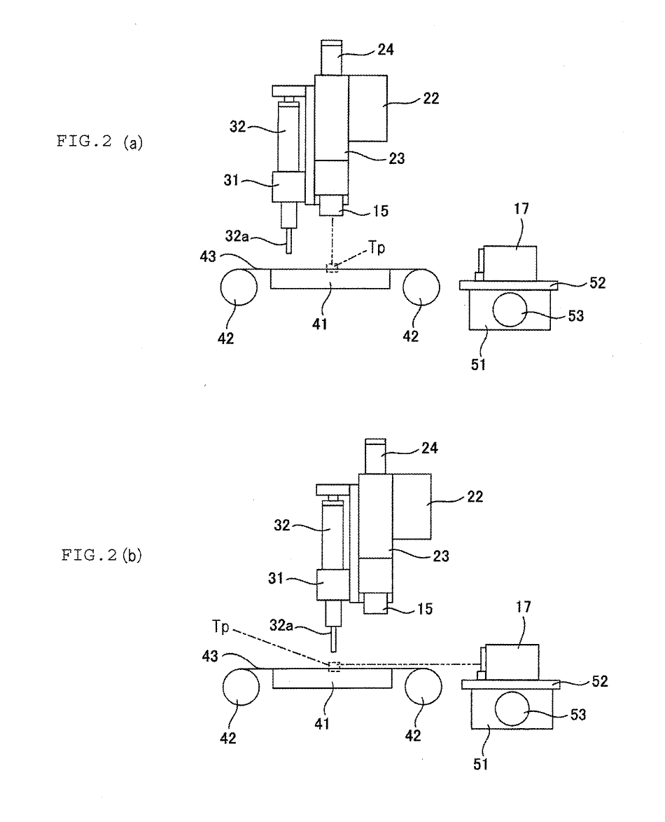

The substrate camera 15 is attached to the movement base 23 of the head movement mechanism 12 with an imaging visual field facing downwardly. The substrate camera 15 images each of a pair of substrate marks 2m provided on the ends of the substrate 2 held by the substrate conveyance conveyor 11 from above. Also, the substrate camera 15 images a region including the test-application points Tp on the test-application stage from above (FIG. 2(a)). The substrate camera 15 can continuously image the plural test-application points Tp from above by being moved in the Y-axis direction by actuation of the head movement mechanism 12.

The relative movement mechanism 16 includes a Y table 51 which is arranged in parallel with a direction of arrangement of the test-application points Tp and extends in the Y-axis direction, and a movement stage 52 movable along the Y table 51, and the movement stage 52 is moved in the Y-axis direction by a motor 53 provided on the Y table 51. The lateral imaging camera 17 is provided on the movement stage 52, and images the region including each of the test-application points Tp on the test-application stage 14 from a lateral direction (X-axis direction) (FIG. 2(b)). The relative movement mechanism 16 forms a relative movement unit that relatively moves the test-application stage 14 and the lateral imaging camera 17 in a horizontal direction, and the lateral imaging camera 17 can image the plural test-application points Tp from the lateral direction by being moved in the Y-axis direction by actuation of the motor 53.

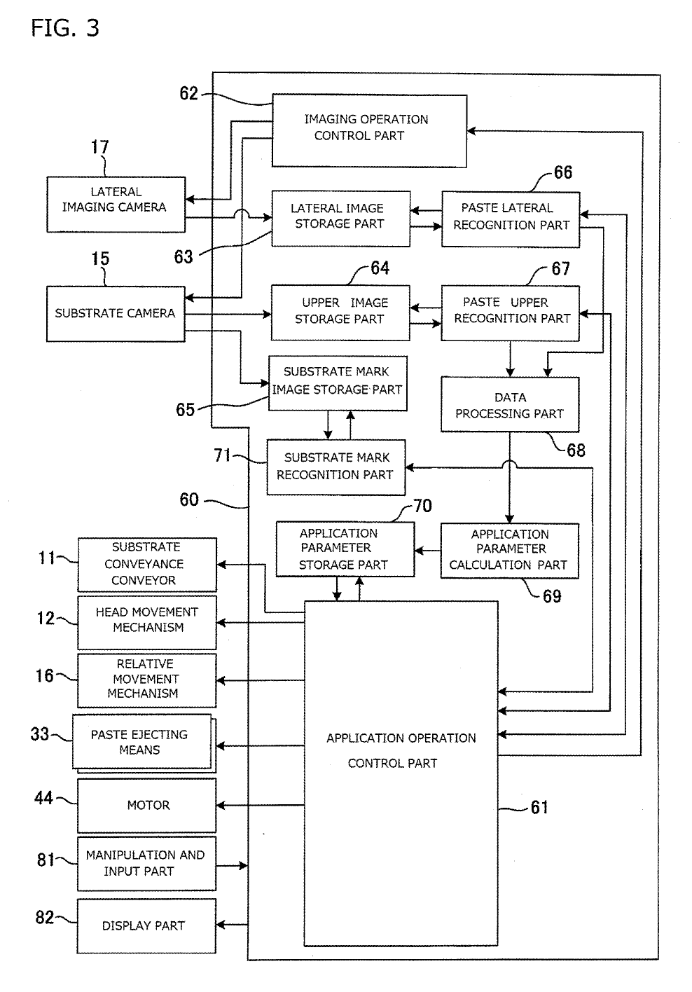

In FIG. 3, an application operation control part 61 of a control part 60 included in the paste application device 1 performs each control of conveyance, positioning and holding operation of the substrate 2 by actuation control of the substrate conveyance conveyor 11, and movement operation of the substrate camera 15 and the application head 13 by actuation control of the head movement mechanism 12. Also, the application operation control part 61 performs each control of ejection operation of the paste Pst from each of the application heads 13 by actuation control of the above paste ejecting means (reference sign 33 in FIG. 3), renewal operation of the test-application region of the test-application stage 14 by actuation control of the motor 44, and movement operation of the lateral imaging camera 17 in the Y-axis direction by actuation control of the motor 53.

In FIG. 3, an imaging operation control part 62 of the control part 60 performs each control of imaging operation by the lateral imaging camera 17 and imaging operation by the substrate camera 15. An image (lateral image) obtained by the imaging operation of the lateral imaging camera 17 is stored in a lateral image storage part 63 (storage part), and an image (upper image) targeting the test-application point Tp on the test-application stage 14 in image data obtained by the imaging operation of the substrate camera 15 is stored in an upper image storage part 64, and an image targeting the substrate mark 2m is stored in a substrate mark image storage part 65.

In FIG. 3, a paste lateral recognition part 66 (paste recognition part) of the control part 60 processes each of the lateral images stored in the lateral image storage part 63, and measures a height (called an “application height”) of the paste Pst applied to each of the test-application points Tp. Also, a paste upper recognition part 67 of the control part 60 processes each of the upper images stored in the upper image storage part 64, and measures an application area of the paste Pst applied to each of the test-application points Tp. Thus, the embodiment is constructed so that the lateral imaging camera 17 is means for imaging the paste Pst applied to the test-application stage 14 by the application head 13 from the lateral direction and the paste lateral recognition part 66 is means for measuring the height of the paste Pst from the image of the paste Pst imaged by the lateral imaging camera 17.

In FIG. 3, a data processing part 68 of the control part 60 totals up data of the application heights of the paste Pst on each of the test-application points Tp measured by the paste lateral recognition part 66 and data of the application areas of the paste Pst on each of the test-application points Tp measured by the paste upper recognition part 67, and performs data processing for calculating respective average values, ranges, maximum values, minimum values, standard deviations, etc. of the application heights and the application areas of the paste Pst.

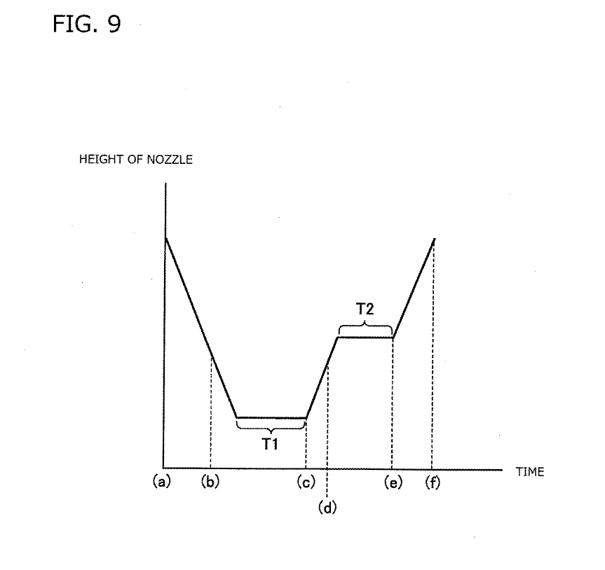

In FIG. 3, an application parameter calculation part 69 of the control part 60 calculates application parameters as application operation conditions based on results of the data processing performed by the data processing part 68, and stores the calculated application parameters together with data of the respective average values, ranges, maximum values, minimum values, standard deviations, etc. of the application heights and the application areas of the paste Pst as the original data in an application parameter storage part 70. The application parameters include the amount of ejection of the paste Pst, a lifting speed of the nozzle 32a, a nozzle height and retention time for an application retention period T1 (FIG. 9), a nozzle height and retention time for a string-cut retention period T2 (FIG. 9), etc.

A substrate mark recognition part 71 of the control part 60 obtains a positional deviation from a reference position of the substrate 2 by processing image data of each of the substrate marks 2m stored in the substrate mark image storage part 65 and grasping a position of the substrate 2 held in the substrate conveyance conveyor 11 and comparing the grasped position of the substrate 2 with a preset reference position.

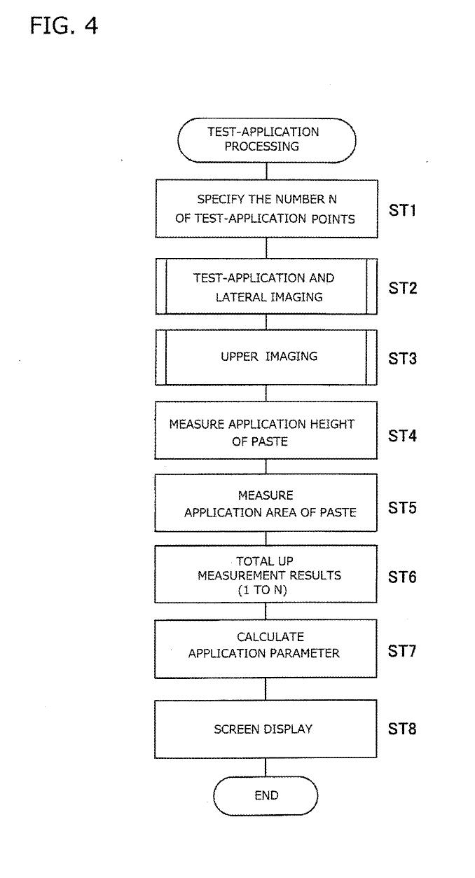

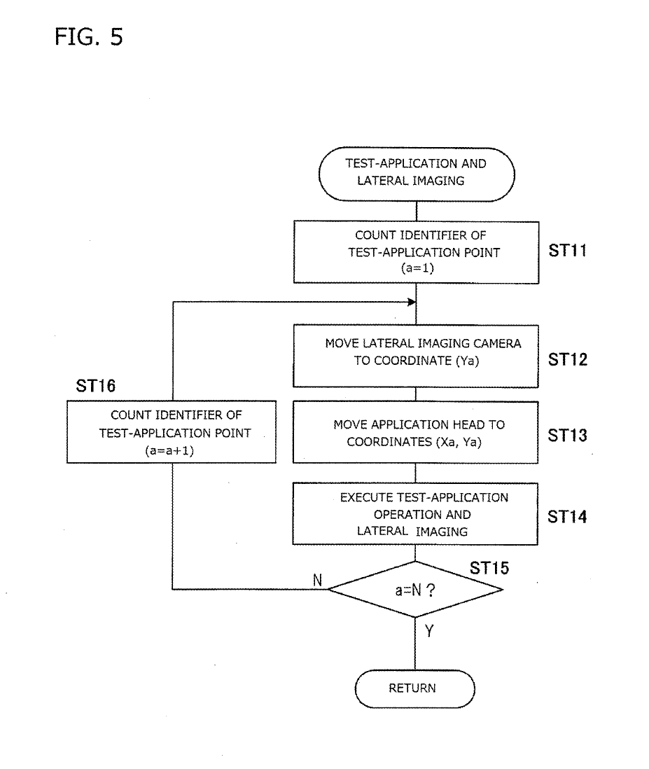

Next, a procedure for executing test-application processing of the paste Pst by the paste application device 1 will be described using flowcharts of FIGS. 4 to 6. When an operator performs a predetermined test-application start manipulation by a manipulation and input part 81 (FIG. 3) connected to the control part 60, the application operation control part 61 specifies “N” as the number of test-application points Tp on the test-application stage 14 where test-application is performed by the application head 13 (step ST1 illustrated in FIG. 4), and proceeds to a subroutine (FIG. 5) of step ST2 of performing test-application of the paste Pst and lateral imaging.

After proceeding to the subroutine of step ST2, the application operation control part 61 first counts an identifier of the test-application point Tp as a=1 (step ST11), and moves the lateral imaging camera 17 to a coordinate (Ya) on the Y table 51 (step ST12), and also moves the application head 13 to coordinates (Xa, Ya) on the head movement mechanism 12 (step ST13). Here, the coordinates (Xa, Ya) are a position just over the test-application point Tp whose identifier is a, and the coordinate (Ya) is a position separate from the test-application point Tp whose identifier is a by a predetermined distance in the Y-axis direction. After the application operation control part 61 moves the lateral imaging camera 17 to the coordinate (Ya) and moves the application head 13 to the coordinates (Xa, Ya), the imaging operation control part 62 executes test-application operation of the paste Pst on the test-application point Tp by the application head 13 and imaging (lateral imaging) of the test-application point Tp by the lateral imaging camera 17 (step ST14). Accordingly, the lateral imaging camera 17 acquires an image of the paste Pst applied to the test-application stage 14 by the test-application operation.

The test-application operation starts extrusion of the paste Pst while downwardly moving the application head 13 after the application head 13 is moved over the test-application stage 14. Then, with the lower end of the nozzle 32a approaching the paper member 43 of the test-application stage 14, a predetermined amount of paste Pst is extruded and after this extrusion is completed, the application head 13 is upwardly moved. Accordingly, the nozzle 32a is separated from the paste Pst while having stringiness of the paste Pst, and the application operation of the paste Pst is completed.

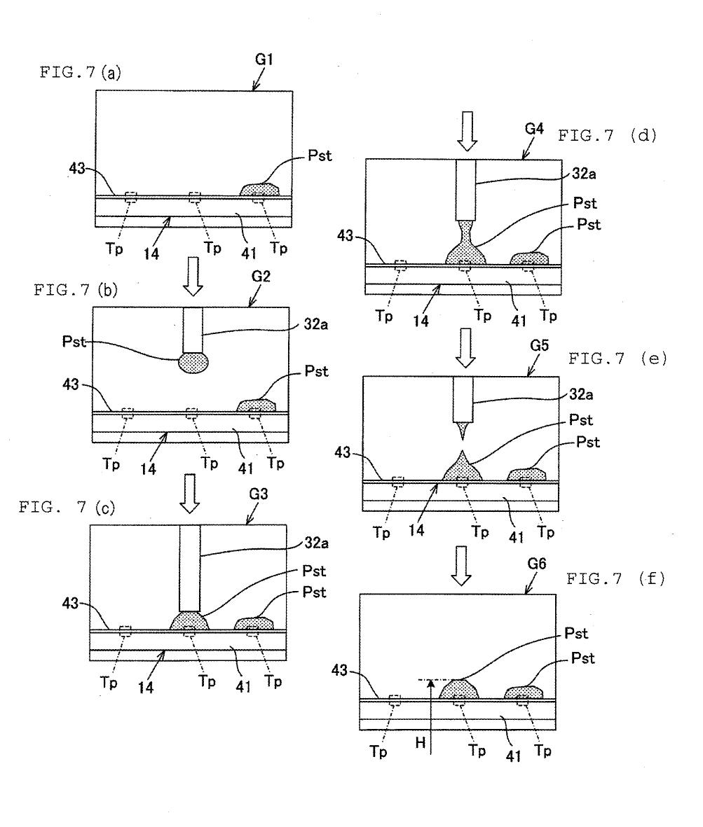

Also, the lateral imaging is executed at plural timings associated with the test-application operation. FIG. 9 is a timing chart illustrating the test-application operation, and illustrates a change in height of the nozzle 32a by the time axis. Also, (a) to (f) described in the time axis indicate imaging timings at which the lateral imaging is performed. After reaching a preset imaging timing, the application operation control part 61 instructs the imaging operation control part 62 to perform imaging by the lateral imaging camera 17. Plural lateral images G1 to G6 (FIGS. 7(a) to 7(f)) acquired by imaging operation of the lateral imaging camera 17 are images obtained by imaging application processes of the paste Pst from the lateral direction, and correspond to the imaging timings (a) to (f) described above. These lateral images G1 to G6 are stored in the lateral image storage part 63.

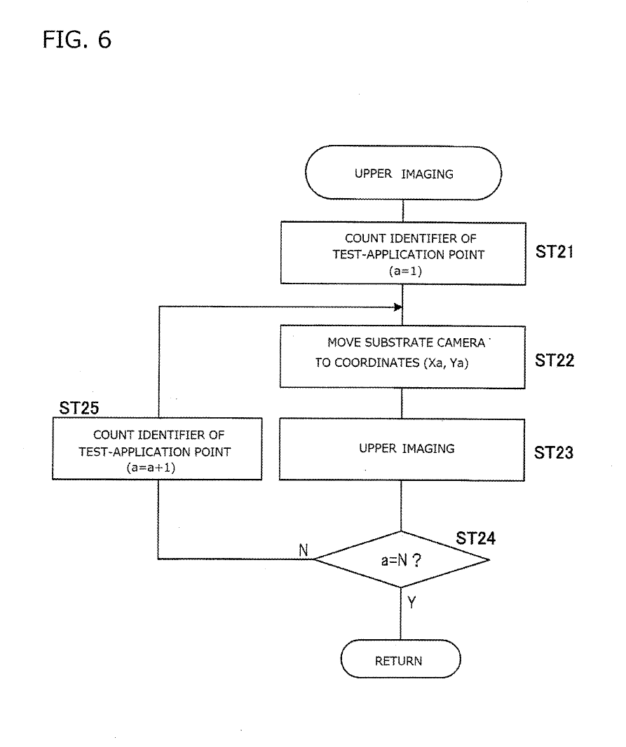

After the operation of application of the paste Pst to the test-application point Tp of the test-application stage 14 is completed and the images of the application processes are stored, the application operation control part 61 decides whether or not the paste Pst is tentatively applied to all the test-application points Tp set in step ST1 of a main routine (whether or not a=N is satisfied) (step ST15). Then, when the paste Pst is not tentatively applied to all the set test-application points Tp, the identifier of the test-application point Tp is counted as a=a+1 (step ST16), and the subroutine returns to step ST12, and imaging of the paste Pst in a new coordinate (Ya) and test-application of the paste Pst in new coordinates (Xa, Ya) are performed. On the other hand, when the paste Pst is tentatively applied to all the set test-application points Tp, the subroutine of step ST2 is exited to return to the main routine. After the subroutine of step ST2 is completed, the application operation control part 61 proceeds to a subroutine (FIG. 6) of step ST3 of performing upper imaging of the tentatively applied paste Pst.

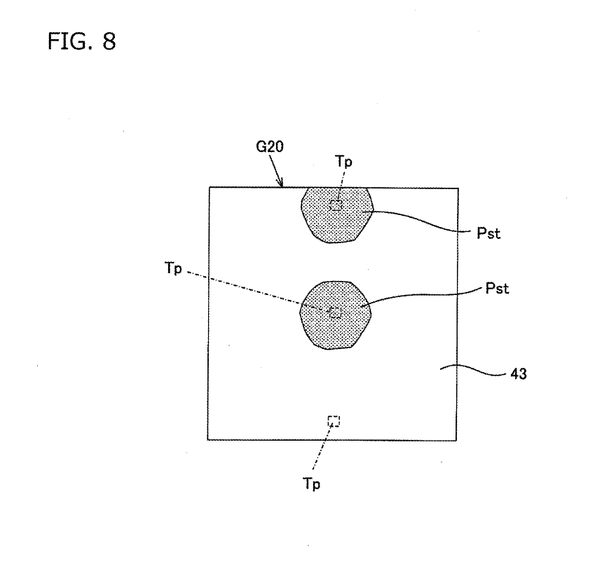

In the subroutine of step ST3, the application operation control part 61 first counts the identifier of the test-application point Tp as a=1 (step ST21), and moves the substrate camera 15 to coordinates (Xa, Ya) on the head movement mechanism 12 (step ST22), and makes the substrate camera 15 perform imaging (upper imaging) of a region including the test-application point Tp on the test-application stage 14 (step ST23). Data of an upper image G20 (FIG. 8) of the test-application point Tp acquired in this manner is stored in the upper image storage part 64 as described above.

After the data of the upper image of the test-application point Tp is stored in the upper image storage part 64, the application operation control part 61 decides whether or not upper imaging of all the test-application points Tp set in step ST1 of the main routine is performed (whether or not a=N is satisfied) (step ST24). Then, when the upper imaging of all the set test-application points Tp is not performed, the identifier of the test-application point Tp is counted as a=a+1 (step ST25), and the subroutine returns to step ST22, and upper imaging is performed in new coordinates (Xa, Ya). On the other hand, when the upper imaging of all the set test-application points Tp is performed, the subroutine of step ST3 is exited to return to the main routine.

After the subroutine of step ST3 is completed, the paste lateral recognition part 66 processes data of lateral images stored in the lateral image storage part 63, and measures an application height H (FIG. 7(f)) of the paste Pst on each of the test-application points Tp (step ST4). Concretely, in the lateral image G6 finally imaged at the test-application points Tp, the highest portion of the applied paste Pst is detected and a height of this portion is adopted as the application height H. The reason why the lateral image G6 finally imaged is used is because a shape of the applied paste Pst is relatively stable.

Then, the paste upper recognition part 67 processes data of upper images stored in the upper image storage part 64, and measures an application area of the paste Pst on each of the test-application points Tp (step ST5).

After the application height and the application area of the paste Pst are measured as described above, the data processing part 68 totals up obtained measurement results, and performs the data processing described above (step ST6). Then, the application parameter calculation part 69 calculates application parameters as application operation conditions based on results of the data processing (step ST7), and stores the application parameters together with the original data in the application parameter storage part 70.

After the application parameters are stored in the application parameter storage part 70, the control part 60 displays the total results in step ST6 together with the lateral images or the upper images on a screen of a display part 82 (FIG. 3) (step ST8). Accordingly, the operator can accurately observe a state of the applied paste Pst. Also, for example, a situation of occurrence of stringiness of the paste Pst in operation of application can be checked.

Also, the control part 60 reads data out of the application parameter storage part 70, and displays the application parameters on the screen of the display part 82 such as a display device. Here, it may be constructed so that respective average values, ranges, maximum values, minimum values, standard deviations, etc. of the application height and the application area of the paste Pst in addition to the application parameters are displayed on the screen according to a manipulation performed by the operator from the manipulation and input part 81.

The test-application processing of the paste Pst is completed as described above, and the operator can also check stringiness of the paste Pst in operation of application by manipulating the manipulation and input part 81 and displaying the lateral images etc. stored by the test-application processing on the display part 82. For example, when the lateral images G3 to G5 imaged in a period after the paste Pst is adhered to the test-application stage 14 until upward movement of the application heads 13 is completed are continuously displayed on the display part 82, a situation of the stringiness can be checked as if the lateral images were animation. Accordingly, the operator can directly correct the application parameters stored in the application parameter storage part 70 according to the checked stringiness while manipulating the manipulation and input part 81.

The paste application device 1 applies the paste Pst to the substrate 2 with the optimum application parameters set as described above. In work of application of this paste Pst, the control part 60 first actuates the substrate conveyance conveyor 11 and carries in the substrate 2 introduced from the outside and stops the substrate 2 in a predetermined work position and holds the substrate 2. Then, the head movement mechanism 12 is actuated and the substrate camera 15 is positioned over the substrate 2, and the substrate camera 15 images a pair of substrate marks 2m on the substrate 2 and the image data is stored in the substrate mark image storage part 65 and on the other hand, the substrate mark recognition part 71 processes the image data of the substrate marks 2m and grasps a position of the substrate 2 and obtains a positional deviation from a reference position of the substrate 2 by the knack described above.

After the positional deviation from the reference position of the substrate 2 is obtained, the control part 60 moves the application head 13 over a position of a target position (electrode) on the substrate 2. Then, the paste Pst is extruded from the syringe 32, and the paste Pst is applied to the electrode. At this time, the control part 60 performs control so as to apply the paste Pst using the application parameters inputted and set from the manipulation and input part 81. Accordingly, the paste Pst is applied to the electrode of the substrate 2 in an optimum application state and subsequently, the substrate 2 is fed to a component mounting apparatus of the downstream side and a component is mounted.

As described above, the paste application device 1 in the embodiment includes the imaging camera (lateral imaging camera 17) for imaging the paste Pst applied to the test-application stage 14 by the application head 13 from the lateral direction, with the result that a state of the applied paste Pst can be observed accurately. Also, since the applied paste Pst applied to the test-application stage 14 is imaged from the lateral direction by the lateral imaging camera 17, imaging is enabled any time regardless of application operation. As a result, a situation of stringiness of the paste Pst occurring in operation of application as well as a state of the paste Pst just after application can be observed.

Also, in the paste application device 1 in the embodiment, the relative movement unit (relative movement mechanism 16) can relatively move the lateral imaging camera 17 with respect to the test-application stage 14 to change a position of the lateral imaging camera 17 with respect to the paste Pst applied to the test-application stage 14, with the result that the plural pastes Pst can be observed more speedily and more accurately. Also, since plural images continuously imaged from the lateral direction are stored, these images are displayed and thereby, the operator can observe a situation of occurrence of stringiness of the paste Pst in operation of application. Further, since the paste recognition part (paste lateral recognition part 66) measures a height of the paste Pst, a state of the applied paste Pst can be grasped by an objective numerical value. In addition, a method for continuously acquiring the plural images may include imaging by animation. By using the animation, the situation of the stringiness of the paste Pst in operation of application can be observed more accurately.

The invention has been described in detail with reference to the specific embodiment, but it is apparent to those skilled in the art that various changes or modifications can be made without departing from the spirit and scope of the invention.

The present application is based on Japanese patent application (patent application No. 2013-048611) filed on Mar. 12, 2013, and the contents of the patent application are hereby incorporated by reference.

### INDUSTRIAL APPLICABILITY

A paste application device capable of observing a state of applied paste speedily and accurately is provided.

### REFERENCE SIGNS LIST

PASTE APPLICATION DEVICE
2 SUBSTRATE
11 SUBSTRATE CONVEYANCE CONVEYOR (SUBSTRATE HOLDING PART)
13 APPLICATION HEAD
14 TEST-APPLICATION STAGE
16 RELATIVE MOVEMENT MECHANISM (RELATIVE MOVEMENT UNIT)
17 LATERAL IMAGING CAMERA (IMAGING CAMERA)
63 LATERAL IMAGE STORAGE PART (STORAGE PART)
66 PASTE LATERAL RECOGNITION PART (PASTE RECOGNITION PART)
Pst PASTE

1. A paste application device comprising:
a substrate holding part that holds a substrate,
an application head that applies paste to the substrate,
a test-application stage in which test-application of the paste is performed,
an imaging camera that images the paste applied to the test-application stage by the application head from a lateral direction, and
a storage part that stores an image imaged by the imaging camera.

2. The paste application device according to claim 1, comprising a relative movement unit that relatively moves the test-application stage and the imaging camera in a horizontal direction.

3. The paste application device according to claim 1, wherein
the imaging camera continuously acquires plural images in a period after the application head downwardly moves to attach the paste to the test-application stage until upward movement of the application head is completed, and
the storage part stores the plural acquired images.

4. The paste application device according to claim 1, comprising
a paste recognition part that measures a height of the paste from the image of the paste imaged by the imaging camera.
